(19) United States
(12) Patent Application Publication
(10) Pub. No.: US 2011/0253399 A1
(43) Pub. Date: Oct. 20, 2011

(54) SOIL AND VEGETATION TOOL

(76) Inventor: Fredric P. Wagner, Temecula, CA (US)

(21) Appl. No.: 12/761,971

(22) Filed: Apr. 16, 2010

(51) Int. Cl. A01D 34/63; A01B 33/06

(52) U.S. Cl. 172/111

(57) ABSTRACT

Provided is a landscaping attachment for use with a landscape trimmer having a rotational drive mechanism. The landscaping attachment includes a ring having an outer surface and an inner surface, with the ring being rotatable about a rotation axis. An attachment plate is connected to the ring and is configured to be engageable with the rotational drive mechanism. The landscape attachment further includes a blade having a proximal end portion and an opposing distal end portion. The proximal end portion is connected to the ring and the distal end portion is disposed radially outward from the ring. The blade defines a cutting plane about the rotation axis as the ring rotates.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates generally to landscaping tools, and more specifically, to an attachment for use with a landscape trimmer, wherein the attachment includes a ring and a blade having a linear cutting edge or a jagged, toothed edge connected to the ring.

Many residential and commercial properties include landscaped areas surrounding the structures built on the properties to enhance the appearance of the property. The landscaped areas may include combinations of hardscape (i.e., masonry work or woodwork) and softscape (flowers, plants, shrubs, trees, grass, etc.). Routine upkeep of the landscaped areas is typically required to maintain the health of the vegetation and the overall appearance of the property. For instance, grass cut on a routine bases, and the plants, shrubs and trees are routinely trimmed.

A string trimmer is a common tool used to cut grass, as well as smaller plants and shrubs near adjacent objects (such as along a driveway, sidewalk, or planting border). Most string trimmers are handheld tools including a long shaft with a cutting head disposed at one end of the shaft. The cutting head typically includes a rotating hub with a cutting line extending from the rotating hub. When the cutting line rotates fast enough, the line is held out rigidly by centripetal forces. As the rigid rotating line passes through tall grass, or small shrubs, the line cuts the grass or shrubs.

Before the string trimmer can be used, the line is first loaded onto the hub of the cutting head. In most cases, the line is wound into the hub with both ends of the line extending outward from the hub. Once the line is loaded on the hub, the trimmer may be used in a manner discussed above. During use of the trimmer, the line oftentimes encounters many hard surfaces, such as rocks, trees, fences, etc., which causes the line to break. Most trimmers are equipped with a release mechanism to release more line as it breaks. The release mechanism may be actuated by tapping the hub on the ground to release more line. Over time, the hub may become tangled, or need to be reloaded with new string, which adds additional time and frustration to a landscaping job.

Another problem associated with string trimmers is that they tend to kick up debris during use. For instance, rocks, dirt, and brush may be thrown by the string as it rotates about the hub. The flying debris may hit someone standing near the trimmer and cause an injury, or the debris may hit a car, window, or the like causing damage to the property.

In addition to trimming, other landscaping tasks are generally required for regular landscaping upkeep. For example, weeds may be need to be cleared to make room for new plants. Furthermore, before the new plants are planted, the soil may require preparation for the new plants. Such routine preparation may include tilling, which generally refers to ploughing, ripping or turning the soil. These additional landscaping tasks typically cannot be completed with a conventional string trimmer and therefore require an additional tool for each task. A string trimmer is typically limited to work above the soil (i.e., trimming grass and weeds), and generally cannot be used for tilling.

As is apparent from the foregoing, there exists a need in the art for an attachment to a landscaping trimmer to mitigate the problems associated breaking and replacing the line in convention string trimmers. There is also a need for separate attachments that can modify the functionality of a conventional line trimmer. The present invention addresses these particular needs, as will be discussed in more detail below.

### BRIEF SUMMARY

As set forth in more detail below, there is provided a landscape attachment configured for use with a conventional landscape trimmer. The unique and novel design of the landscape attachment addresses many of the deficiencies associated with traditional string trimmers, such as broken string, tangled string, and flying debris. Various landscape attachments may be used with a single landscape trimmer to enhance the overall functionality of the trimmer. Along these lines, each landscape attachment may be adapted for quick and easy installation and detachment to and from the landscape trimmer to allow a user to easily change the functionality of the landscape trimmer.

According to one embodiment, there is provided is a landscaping attachment for use with a landscape trimmer having a rotational drive mechanism. The landscaping attachment includes a ring having an outer surface and an inner surface, with the ring being rotatable about a rotation axis. An attachment plate is connected to the ring and is configured to be engageable with the rotational drive mechanism. The landscape attachment further includes a blade having a proximal end portion and an opposing distal end portion. The proximal end portion is connected to the ring and the distal end portion is disposed radially outward from the ring. The blade defines a cutting plane about the rotation axis as the ring rotates.

According to another embodiment, there is provided a landscaping attachment having a ring disposed about a rotation axis, with the ring having an outer surface and an inner surface. An attachment plate is connected to the ring and is configured to be engageable with the rotational drive mechanism. A blade is connected to the ring and extends in a first direction along the rotation axis and a second direction in a plane perpendicular to the rotation axis.

The blade may define a linear cutting edge suitable for cutting grass, weeds and the like, or a jagged, toothed cutting edged suitable for tilling soil.

According to yet a further embodiment, there is provided a landscaping tool including a ring having an outer surface and an inner surface. An attachment plate is connected to the ring, and includes a rotary attachment portion and a blade attachment portion. The rotary attachment portion is configured to be engageable with the rotational drive mechanism, while the blade attachment portion is configured to be engageable with a blade. Various blades may be connected to the attachment to adapt the functionality thereof.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an exploded upper perspective view of a landscaping tool having a pair of blades extending radially outward from a ring, and an end cap;

FIG. 2 is a side sectional view of the landscaping tool shown in FIG. 1;

FIG. 3 is a bottom view of the landscaping tool shown in FIG. 1;

FIG. 4 is a bottom view of a landscaping tool having a pair of blades which are longer than the blades depicted on the tool shown in FIG. 3;

FIG. 5 is a lower perspective view of a landscaping tool having a pair of blades extending within a ring, with each blade defining a linear cutting edge;

FIG. 6 is a bottom view of the landscaping tool depicted in FIG. 5;

FIG. 7 is a side sectional view of the landscaping tool depicted in FIG. 6;

FIG. 8 is a lower perspective view of a landscaping tool having a pair of saw-toothed blades extending within a ring;

FIG. 9 is a bottom view of the landscaping tool depicted in FIG. 8;

FIG. 10 is a side sectional view of the landscaping tool depicted in FIG. 8;

FIG. 11 is a side sectional view of a landscaping tool having a pair of detachable blades;

FIG. 12 is a bottom view of the landscaping tool depicted in FIG. 11;

FIG. 13 is an upper perspective view of the landscaping tool depicted in FIG. 11; and

FIG. 14 is a lower perspective view of the landscaping tool depicted in FIG. 11.

### DETAILED DESCRIPTION

The detailed description set forth below in connection with the appended drawings is intended as a description of certain embodiments of the present disclosure, and is not intended to represent the only forms that may be developed or utilized. The description sets forth the various functions in connection with the illustrated embodiments, but it is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

The drawings depict a number of different attachments configured for use with a conventional landscape trimmer. Various aspects of the attachments are directed toward addressing the deficiencies of conventional string trimmers, such as broken string, tangled string, flying debris, and limited functionality of string trimmers. As described in more detail below, the various attachments include cutting blades and may be designed for use without string and may be interchangeably used with a trimmer to enhance the functionality of the trimmer. Exemplary functions which may be performed by the depicted attachments include trimming, edging, tilling, and cutting brush, shrubs and weeds. In addition, the innovative design may reduce the amount of debris thrown by the trimmer during use.

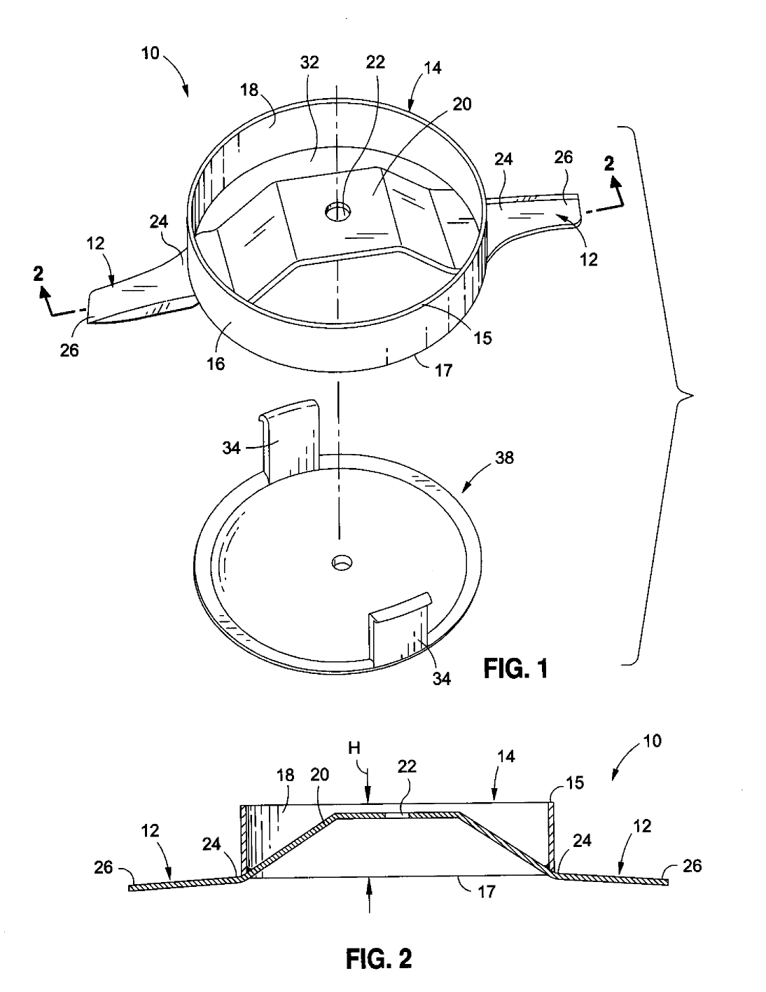

Referring now specifically to FIGS. 1-3, there is depicted a first embodiment of an attachment 10 having a pair of blades 12 extending radially outward from a ring 14. The ring 14 includes an outer surface 16, an inner surface 18, an upper surface 15 and a lower surface 17 to define a ring height “H” between the upper surface 15 and the lower surface 17. The attachment 10 further includes an engagement portion 20 connected to the ring 14, with the engagement portion 20 being configured for engagement with a rotational drive mechanism on the landscape trimmer. In the exemplary embodiment shown in the figures, the engagement portion 20 includes an attachment aperture 22 for connecting the attachment 10 to the trimmer such that when the rotation mechanism rotates, the attachment 10 also rotates. Moreover, as the attachment 10 rotates, the blades 12 define a cutting plane about the rotation axis. As is best depicted in FIG. 2, the blades 12 and engagement portion 20 are integrally connected to define a single unit which is welded, or otherwise fastened, to the ring 14. It is also contemplated that other embodiments of the attachment 10 may include blades 12 and an engagement portion 20 which are separate elements individually fastened to the ring 14.

As shown in FIGS. 1-3, the blades 12 are disposed on diametrically opposed portions of the ring 14, and are equally spaced about the ring 14 (i.e., approximately 180 degrees apart). Along these lines, if the attachment 10 includes three blades 12, the blades 12 may be spaced approximately 120 degrees apart; four blades 12 may be 90 degrees apart, etc. However, it is also understood that other implementations may include blades 12 which are unevenly spaced about the ring 14.

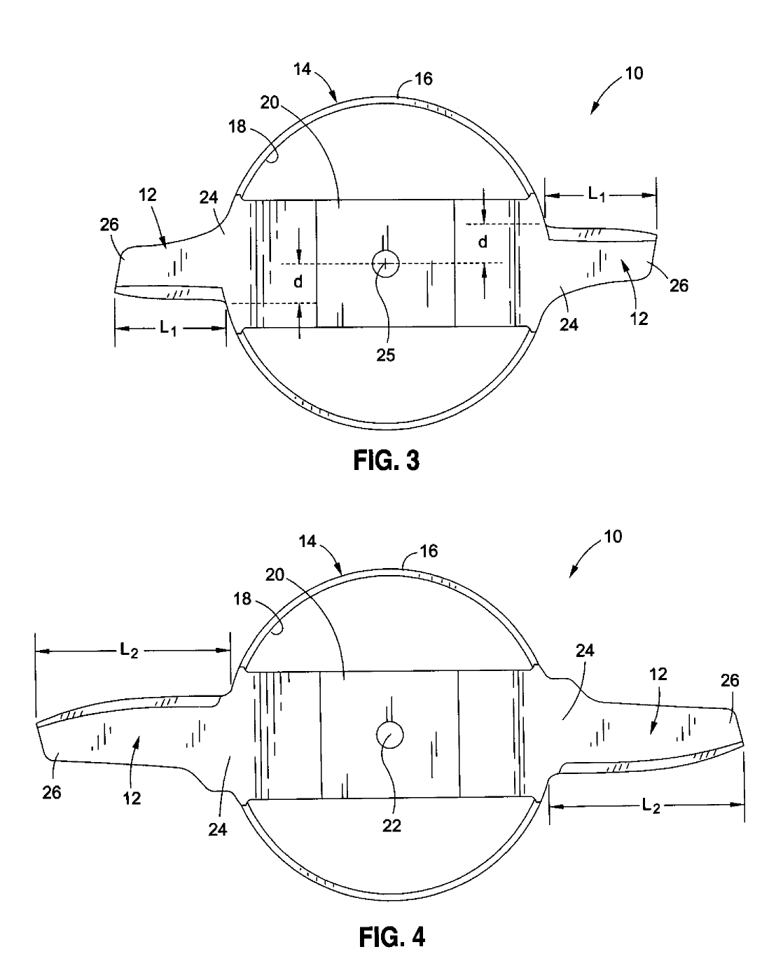

Each blade 12 includes a proximal end portion 24 disposed adjacent the ring 14, and a distal end portion 26 disposed away from the ring 14 and a cutting edge extending along a cutting edge axis. The blade 12 may extend perpendicularly from the ring 14, or in other implementations, the blade 12 may be angled upward from the ring 14 so as to mitigate contact with the ground (i.e., dirt, rocks, etc.), which may extend the life of the blade 12, as well as reduce the amount of debris projected by the trimmer. It is also contemplated that the blade 12 may be angled downward without departing from the spirit and scope of the present invention. Furthermore, the cutting edge may define a linear configuration, or a non-linear (i.e., curved) configuration). The blades 12 define a blade length L₁ (see FIG. 3) as the distance between the distal most portion of the blade 12 and the ring 14. As is best depicted in FIG. 3, the cutting edge axis of each blade 12 is offset from the midpoint 25 of the ring 14 by an offset distance “d”. It is contemplated that the offset distance d may be varied depending on the size or power of the trimmer used with the attachment 10. In particular, the offset distance d may be increased for larger, more powerful trimmers, or decreased for smaller, less powerful trimmers.

The ring 14 may be specifically configured to improve the cutting efficiency of the attachment 10. More specifically, the height H of the ring 14 may be used to hold up the weeds or brush to be cut by the blades 12. This is contrasted with conventional string trimmers which typically include hubs which tend to knock vegetation out of the cutting path before the vegetation is cut by the string. In this regard, the ring-blade design of the attachment 10 may be more effective when trimming weeds and other brush. Furthermore, the contact between the weed and the ring 14 reduces the amount of debris projected by the attachment 10, relative to conventional string trimmers. In some instances, the attachment 10 may reduce the amount of debris projected by the trimmer by 90%.

The inner surface 18 of the ring 14 defines a ring opening 32 extending from the upper surface 15 to the lower surface 17. It is contemplated that twigs or branches may extend through the ring opening 36 during use of the attachment 10 which may inhibit rotation of the attachment 10. Therefore, an end cap 38 may be connected to the attachment 10 to substantially cover the ring opening 32 for deflecting twigs, branches, and the like away from the ring opening 32. The exemplary end cap 38 depicted in the figures includes a pair of spring biased tabs 34 which engage with the ring 14 to couple the end cap 38 to the ring 14. The spring biased tabs 34 may be inserted into the ring opening 32 and engage with the inner surface 18 of the ring 14 by being biased radially outward. However, other embodiments of the end cap 38 may include spring biased tabs 34 which engage with the outer surface 16 of the ring 14 and are biased radially inward. Furthermore, although the end cap 38 shown in FIG. 1 only includes two tabs 34, it is contemplated that other embodiments may include more than two tabs 34 (i.e., three tabs, four tabs, etc.). The end cap 38 may be fabricated out of a plastic material and include a molded in, or detachable metal portion in the center of the end cap 38 to enhance the strength and durability thereof.

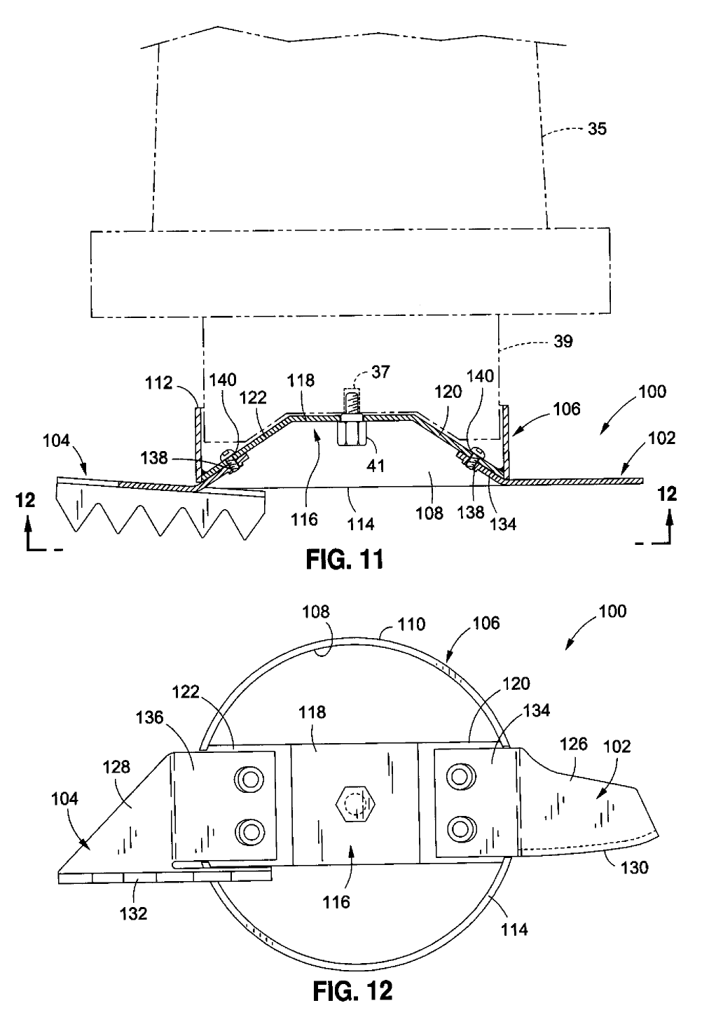

It is contemplated that the trimmer 35 (see FIG. 11) may include an internally threaded recess 37 (see FIG. 11) extending into the rotation mechanism 39 (see FIG. 11) for engagement with the attachment 10. The attachment aperture 22 may be aligned with the recess 37, and a screw 41 (see FIG. 11) may be advanced through the aperture 22 and into the recess 37 to connect the attachment 10 to the trimmer 35. Alternatively, the trimmer 35 may include an axle (not shown) which may be advanced through the aperture 22 for connecting the attachment 10 to the trimmer 35. Other connection means known by those skilled in the art may also be employed without departing from the spirit and scope of the present invention.

Referring now to FIG. 4, there is depicted a second embodiment of the attachment 10 which is similar to the embodiment depicted in FIGS. 1-3, and differs only in the length of the blade 12. In particular, each blade 12 in FIG. 4 defines a blade length L₂, which is longer than the blade length L1 shown in FIGS. 1-3. A longer blade 12 may be desirable to define a larger cutting footprint (i.e., the area covered by the blades 12 during each rotation), as well as to cut larger vegetation. The shorter blade 12 depicted in FIGS. 1-3 may be more desirable for achieving more precise and accurate cutting, such as around plants and vegetation which a user does not want to cut.

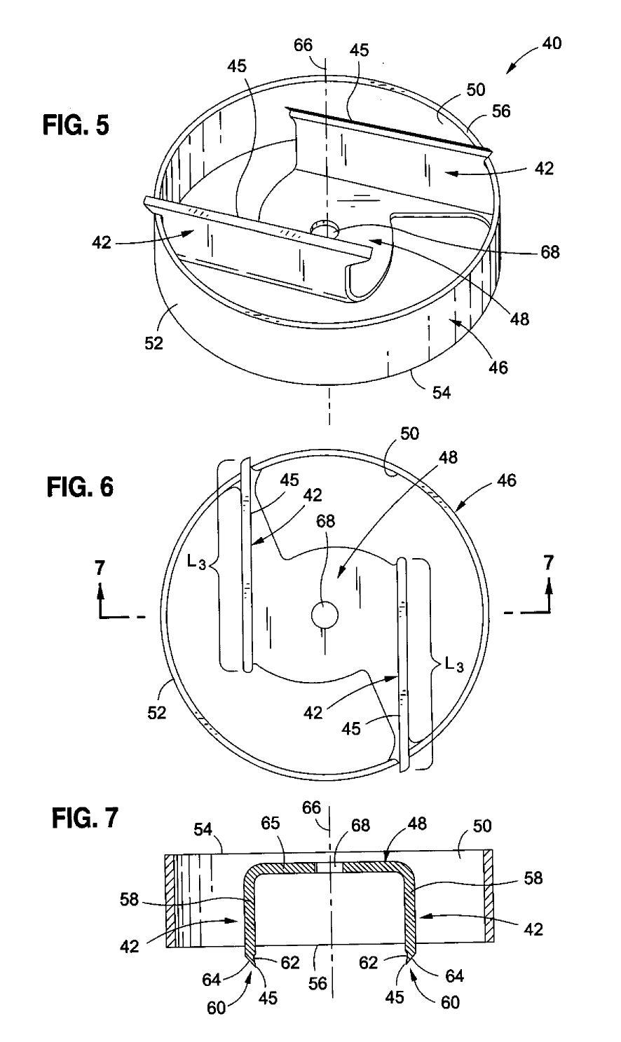

The above-described attachments 10 include blades 12 that extend radially outward from the ring 14 in a plane substantially perpendicular to the rotation axis. Referring now to FIGS. 5-10, there are depicted various attachments having blades extending within the ring 14 in a first direction along the axis of rotation 66 and a second direction in a plane perpendicular to the axis of rotation 66. Referring first to FIGS. 5-7, there is shown an attachment 40 including a pair of blades 42 having a linear cutting edge 45 which may be useful for clearing weeds or brush. The attachment 40 includes a ring 46, a pair of blades 42, and an attachment portion 48 for connecting the attachment 40 to the trimmer. The ring 46 includes an inner surface 50, an outer surface 52, an upper surface 54 and a lower surface 56. The blades 42 extend primarily within the ring 46, with only a small portion of each blade 42 extending beyond the ring 46. It is contemplated that other embodiments of the attachment 40 may include blades 42 which extend exclusively within the ring 46.

Each blade 42 defines a blade length L₃ with the blade lengths L₃ being substantially equal to each other. The blades 42 are disposed in generally parallel relation to each other and extend only partially across the ring 46. In this manner, the exemplary embodiment includes a blade length L₃ that is less than the diameter of the ring 46, but greater than the radius of the ring 46; however, other blade lengths may also be employed. The blades 42 are additionally disposed in a staggered configuration, with each blade 42 extending from diametrically opposed positions of the ring 46.

Referring now specifically to FIG. 7, the blade 42 includes a blade body 58 and a blade tip 60 protruding beyond the lower surface 56 of the ring 46. Each blade tip 60 includes a medial surface 62 and a lateral surface 64, with the medial and lateral surfaces 62, 64 intersecting along the cutting edge 45. The medial surface 62 and/or the lateral surface 64 may be canted or angularly disposed relative to the blade body 58. As shown in FIG. 7, each blade tip 60 is angled toward the rotation axis 66 (i.e., toward each other), although other implementations may include blade tips 60 angled away from the rotation axis 66 (i.e., away from each other). The attachment 40 may be configured to rotate in a direction such that the blade tips 60 are the leading edges of the respective blades 42. For instance, in the embodiment shown in FIG. 6, the attachment 40 rotates in a clockwise direction.

The attachment portion 48 includes an engagement plate 65 (see FIG. 7) and an engagement aperture 68 formed within the engagement plate 65. The attachment 40 may be coupled to the landscape trimmer in a manner similar to that discussed above in relation to the attachment 10. The blades 42 may be integrally formed with the attachment portion 48, and extend generally perpendicularly from the engagement plate 65, with the attachment portion 48 and blades 42 being welded to the ring 46.

FIGS. 5-7 depict a preferred embodiment of the attachment 40, but it should be noted that other configurations of the attachment 40 may be employed without departing from the spirit and scope of the present invention. For instance, other embodiments may include curved blades 42, as well as non-parallel blades 42 (i.e., blades 42 angled toward each other, or away from each other). Furthermore, the distal portion of the blade 42 may also be varied to define various cutting surfaces known by those skilled in the art.

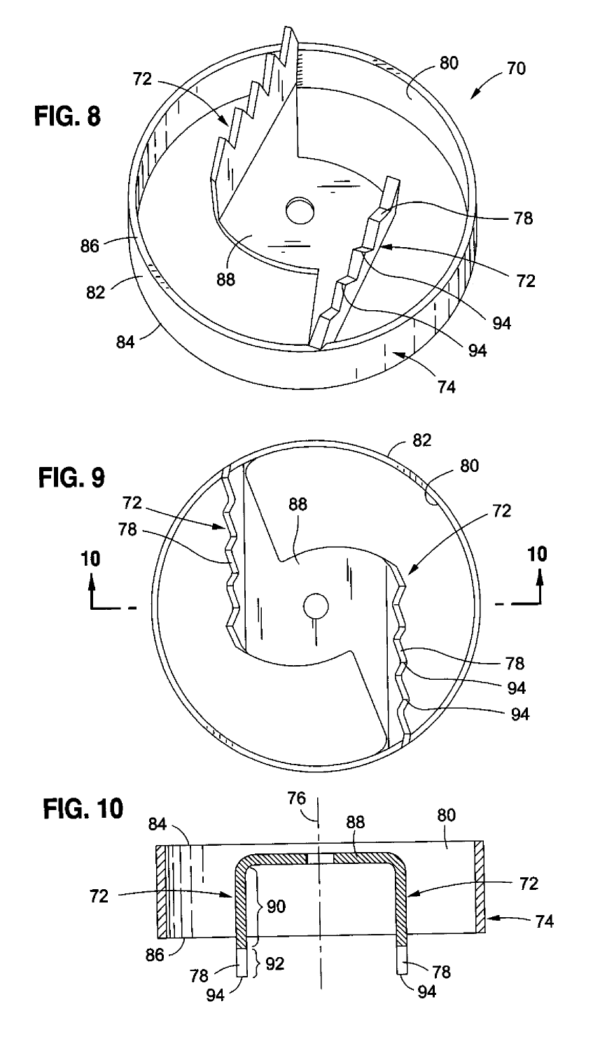

Referring now to FIGS. 8-10, there is depicted a third embodiment of an attachment 70. The attachment 70 is similar to the attachment 40 in that it includes a pair of blades 72 extending within a ring 74 in a first direction along the axis of rotation 76 and a second direction in a plane perpendicular to the axis of rotation 76. The primary distinction between the attachment 70 and the attachment 40 being that the attachment 70 includes blades 72 include saw-toothed cutting edges 78 (rather than the linear cutting edges 45 of attachment 40). The saw-toothed cutting edges 78 may be advantageously configured for tilling or churning the soil. In this manner the saw-toothed portions of the blades 72 may extend into the soil while the attachment 70 rotates.

The ring 74 includes an inner surface 80, an outer surface 82, an upper surface 84 and a lower surface 86. In the exemplary embodiment, the blades 72 do not extend radially beyond the outer surface 82 of the ring 74, although other implementations may include blades 72 that do extend radially beyond the outer surface 82. The blades 72 extend along a first direction substantially perpendicular to the rotation axis 76 in generally parallel relation to each other from diametrically opposed portions of the ring 74. The blades 72 also extend in a second direction along the rotation axis 76 beyond the lower surface 86 of the ring 74 so as to enable the blades 72 to extend into the soil. The blades 72 shown in FIG. 10 extend generally perpendicularly from the attachment portion 88 in the second direction; however, it should be noted that the blades 72 may extend in a non-perpendicular direction from the attachment portion 88 without departing from the spirit and scope of the present invention.

The blades 72 include a body portion 90 (see FIG. 10) and a tooth portion 92 (see FIG. 10) extending from the body portion 90. The tooth portion 92 defines a series of teeth, with each tooth terminating at a distal tip 94. Each blade 72 depicted in the Figures includes five distal tips 94, although blades 72 having fewer than five distal tips 94 or more than five distal tips 94 may also be used without departing from the spirit and scope of the present invention. Furthermore, other implementations may include blades 72 which are curved or disposed in non-parallel relation to each other.

One aspect of the attachments 40, 70 is that the respective rings 46, 74 may define a periphery within which the blades 42, 72 may rotate and cut. In this manner, the attachments 40, 70 may be used among plants and shrubs while reducing the risk of inadvertently cutting the plants and shrubs. In other words, the attachments 40, 70 may safely glide next to and around plants, bushes, boarders, and chain link fences with ease.

Referring now to FIGS. 11-14, there is depicted another embodiment of an attachment 100 having detachable blades 102, 104 for enhancing the functional capabilities of the attachment 100. The blades 102, 104 may be similar to the blades included in the various embodiments discussed above. The attachment 100 includes a ring 106 having an inner surface 108, and outer surface 110, an upper surface 112 and a lower surface 114. An attachment element 116 is connected to the ring 106 and includes an engagement plate 118, a first blade portion 120 and a second blade portion 122. The engagement plate 118 includes an engagement aperture 124 formed therein for connecting the attachment 100 to the trimmer 35. As shown in FIG. 11, a bolt 41 may be advanced through the aperture 124 and into a recess 37 formed within the trimmer 35 to connect the attachment 100 to the trimmer 35.

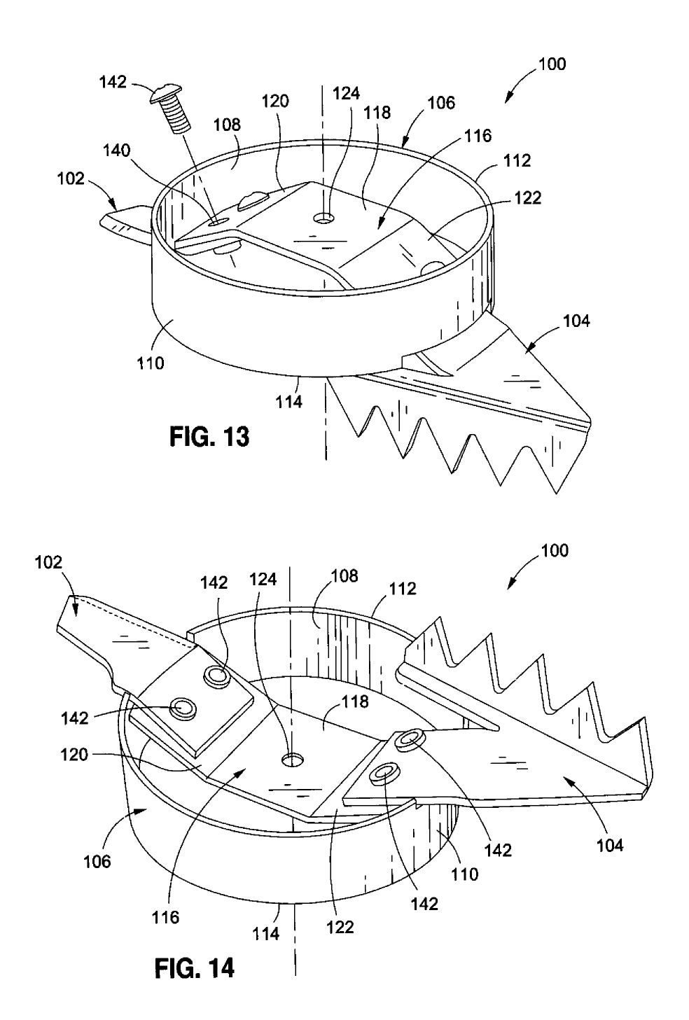

Each blade 102, 104 may be configured to be attachable to either the first blade portion 120 or the second blade portion 122. In particular, each blade 102 includes a blade body 126, 128 defining a cutting edge 130, 132, and an engagement plate 134, 136 connected to the blade body 126, 128. The engagement plate 134, 136 includes apertures 138 (see FIG. 13) which are aligned with apertures 140 formed within the blade portions 120, 122 of the attachment element 116. When the apertures 138, 140 are aligned, a screw 142, or other mechanical fastener may be inserted through the apertures 138, 140 to couple the blades 102, 104 to the ring 106. The screws 142 may be easily inserted and removed to adapt the functionality of the attachment 100 to the user's tasks.

Other embodiments of the attachment 100 may be configured to detachably couple the blades 102, 104 thereto by other detachable coupling means known by those skilled in the art. For instance, the blades 102, 104 may define a tongue which is complimentary to a groove formed within the first and second blade portions 120, 122 to couple the blades 102, 104 to the attachment 100.

The rings discussed above in relation to the various attachments 10, 40, 70 100 may define various sizes, preferably four inches to seven inches in diameter; although rings smaller than four inches and larger than seven inches in diameter may also be used. Furthermore, the attachments 10, 40, 70, 100 may be fabricated from a material capable of withstanding repeated usage thereof, such as tough, hardened steel, or other materials known materials in the art. With regard specifically to the blades, a material may be used such that the blades are strong enough to perform the desired landscaping functions, yet soft enough to allow a user to sharpen the blades. The attachments 10, 40, 70, 100 may additionally include a powder coat type finish.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A landscaping tool for use with a landscape trimmer having a rotational drive mechanism, the landscaping tool comprising:
a ring having an outer surface and an inner surface, the ring being rotatable about a rotation axis;
an attachment plate connected to the ring, the attachment plate configured to be engageable with the rotational drive mechanism; and
a blade having a proximal end portion and an opposing distal end portion, the proximal end portion being connected to the ring and the distal end portion being disposed radially outward from the ring, the blade defining a cutting plane about the rotation axis as the ring rotates.

2. The landscaping tool recited in claim 1, wherein the blade defines a cutting edge extending from the ring along a blade axis, the ring being disposed about a midpoint, the blade axis being offset from the midpoint.

3. The landscaping tool recited in claim 1, wherein the cutting plane is substantially perpendicular to the outer surface of the ring.

4. The landscaping tool recited in claim 1, wherein the blade includes a pair of blades disposed on diametrically opposed portions of the ring.

5. The landscaping tool recited in claim 4, wherein each blade defines a cutting edge extending from the ring along a blade axis, the pair of blade axes being disposed in spaced, parallel relation to each other.

6. The landscaping tool recited in claim 1, wherein the outer surface defines an outer diameter of approximately four inches.

7. The landscaping tool recited in claim 1, wherein the inner surface defines a ring opening, the landscaping tool further comprising an end cap engageable with the ring to cover the ring opening to mitigate brush from entering the ring opening.

8. The landscaping tool recited in claim 7, wherein the end cap includes a pair of spring biased tabs engageable with the ring to securing the end cap to the ring.

9. A landscaping tool for use with a landscape trimmer having a rotational drive mechanism, the landscaping tool comprising:
a ring disposed about a rotation axis, the ring having an outer surface and an inner surface;
an attachment plate connected to the ring, the attachment plate configured to be engageable with the rotational drive mechanism; and
a blade connected to the ring and extending in a first direction along the rotation axis and a second direction in a plane perpendicular to the rotation axis.

10. The landscaping tool recited in claim 9, wherein the blade includes a recessed portion disposed within the ring and a protruding portion extending out of the ring.

11. The landscaping tool recited in claim 10, wherein the protruding portion defines a toothed-edge configured for tilling.

12. The landscaping tool recited in claim 10, wherein the protruding portion defines a blade having a substantially linear cutting edge.

13. The landscaping tool recited in claim 10, wherein the blade includes a pair of blades connected to diametrically opposed portions of the ring.

14. The landscaping tool recited in claim 10, wherein each blade extends into the ring from the inner wall along an element axis, the pair of element axes being disposed in spaced, parallel relation to each other.

15. A landscaping tool for use with a landscape trimmer having a rotational drive mechanism, the landscaping tool comprising:
a ring having an outer surface and an inner surface;
an attachment plate connected to the ring, the attachment plate having a rotary attachment portion and a blade attachment portion, the rotary attachment portion configured to be engageable with the rotational drive mechanism; and
a blade detachably engageable with the blade attachment portion of the attachment plate.

16. The landscaping tool recited in claim 15, wherein the blade includes a blade having a cutting edge extending along an axis that is generally perpendicular to the outer surface of the ring.

17. The landscaping tool recited in claim 15, wherein the blade includes a toothed-edge configured for tilling.

18. The landscaping tool recited in claim 15, wherein the blade attachment portion includes a pair of blade attachment portions, and the blade includes a pair of blades detachably engageable to respective ones of the pair of blade attachment portions.

19. The landscaping tool recited in claim 18, wherein at least one of the pair of blades includes a blade with a substantially linear cutting edge.

20. The landscaping tool recited in claim 18, wherein at least one of the pair of blades includes a toothed-edge configured for tilling.
